(19) United States
(12) Patent Application Publication
(10) Pub. No.: US 2026/0285369 A1
(43) Pub. Date: Sep. 24, 2026

(54) VEHICLE

(71) Applicant: TOYOTA JIDOSHA KABUSHIKI KAISHA, Toyota-shi (JP)

(72) Inventors: Takeshi KANOU, Seto-shi (JP); Kazuhiko UEDA, Tokyo (JP); Daisuke KAKUMA, Numazu-shi (JP); Satoshi TAKAHASHI, Yokohama-shi (JP); Hiroya CHIBA, Fuji-shi (JP); Sen YANG, Susono-shi (JP); Naufal Takbir IBRAHIM, Numazu-shi (JP)

(73) Assignee: TOYOTA JIDOSHA KABUSHIKI KAISHA, Toyota-shi (JP)

(21) Appl. No.: 19/443,380

(22) Filed: Jan. 8, 2026

(30) Foreign Application Priority Data
Mar. 21, 2025 (JP) 2025-046295

(51) Int. Cl. B60W 60/00; B60W 30/18

(52) U.S. Cl. CPC B60W 60/0015; B60W 30/181; B60W 2556/45

(57) ABSTRACT

A vehicle according to the present disclosure is a vehicle that operates in response to an instruction from a management device and that can move by unmanned driving, the vehicle includes: a communication unit that communicates with the management device; a determination unit that determines a communication status between the communication unit and the management device; and a controller that controls the vehicle to perform a predetermined operation according to a traveling area in a case where determination is made that the communication between the communication unit and the management device is interrupted.

### CROSS-REFERENCE TO RELATED APPLICATION

This application claims priority to Japanese Patent Application No. 2025-046295 filed on March 21, 2025. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

In recent years, development of a management system that remotely manages the operation of a plurality of vehicles (that is, autonomous driving transport vehicles) that can move via unmanned driving has been advanced. For example, Japanese Patent No. 7424535 (JP 7424535 B) discloses a device that remotely controls a moving object.

### SUMMARY

In a management system that remotely manages the operation of a plurality of autonomous driving transport vehicles, it is desirable to appropriately perform management to ensure safety in a case where communication between each autonomous driving transport vehicle and a management device is interrupted.

The present disclosure has been made in view of the above background, and an object thereof is to provide a vehicle that can execute an appropriate retreat operation in a case where communication with a management device is interrupted.

A vehicle according to the present disclosure is a vehicle that operates in response to an instruction from a management device and that is able to move via unmanned driving, the vehicle includes:

a communication unit configured to communicate with the management device; a determination unit configured to determine a communication status between the communication unit and the management device; and a controller configured to control, in a case where determination is made that communication between the communication unit and the management device is interrupted, the vehicle such that the vehicle performs a predetermined operation according to a traveling area. The vehicle according to the present disclosure controls, in a case where the communication with the management device that manages an operation of the vehicle is interrupted, the vehicle such that the vehicle performs the predetermined operation according to the traveling area. For example, in a case where the vehicle according to the present disclosure is traveling on rollers of a chassis dynamometer, the vehicle gradually reduces the speed such that the vehicle body does not fly out from the rollers, and in a case where the vehicle travels in an area other than the rollers, the vehicle stops quickly, for example. As a result, the vehicle according to the present disclosure can execute an appropriate retreat operation in a case where the communication with the management device is interrupted.

According to the present disclosure, it is possible to provide a vehicle that can execute an appropriate retreat operation in a case where communication with a management device is interrupted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a part of a vehicle management system according to Embodiment 1;

FIG. 2 is a block diagram showing a control system of the vehicle management system according to Embodiment 1;

FIG. 3 is a diagram for describing traveling control of the vehicle;

FIG. 4 is a control block diagram for describing a traveling control example 1;

FIG. 5 is a flowchart for describing the traveling control example 1;

FIG. 6 is a control block diagram for describing a traveling control example 2; and

FIG. 7 is a flowchart for describing the traveling control example 2.

### DETAILED DESCRIPTION OF EMBODIMENTS

Hereinafter, specific embodiments of the disclosure will be described in detail with reference to the drawings. Note that the embodiments of the disclosure are not limited to the following embodiments. Further, in order to clarify the explanation, the following description and drawings are appropriately simplified.

### Embodiment 1

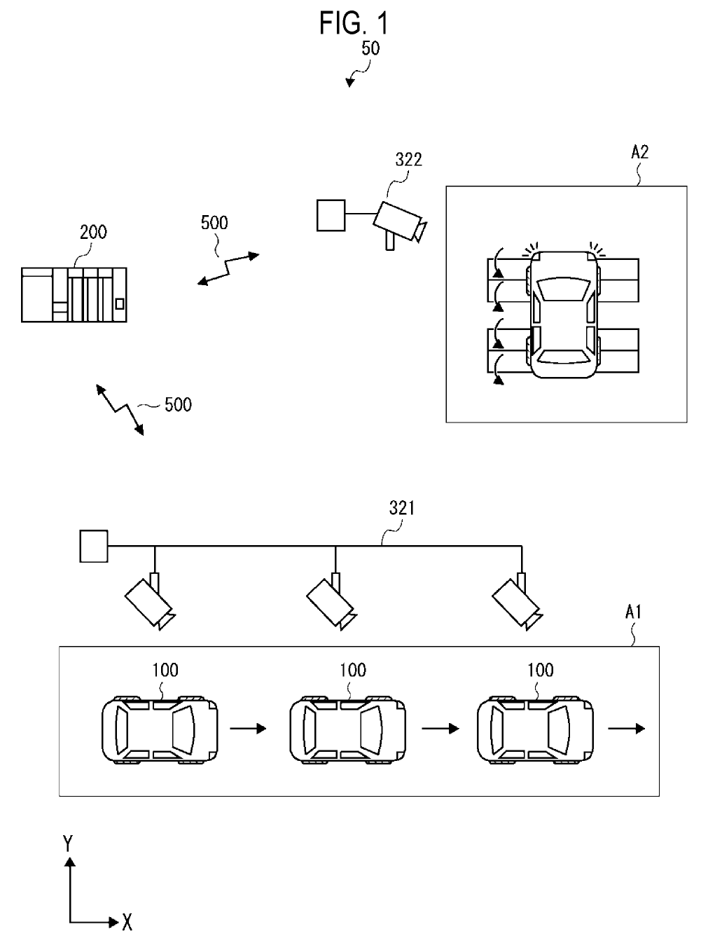

FIG. 1 is a schematic diagram showing a part of a vehicle management system 50 according to Embodiment 1. The vehicle management system 50 is applied to, for example, a vehicle manufacturing factory that manufactures a vehicle 100. In the example of FIG. 1, the vehicle management system 50 monitors and manages a plurality of vehicles 100 positioned in each of an area A1 in which a predetermined operation is performed and an area A2 in which test traveling is performed. In FIG. 1, an XY orthogonal coordinate system is shown for description.

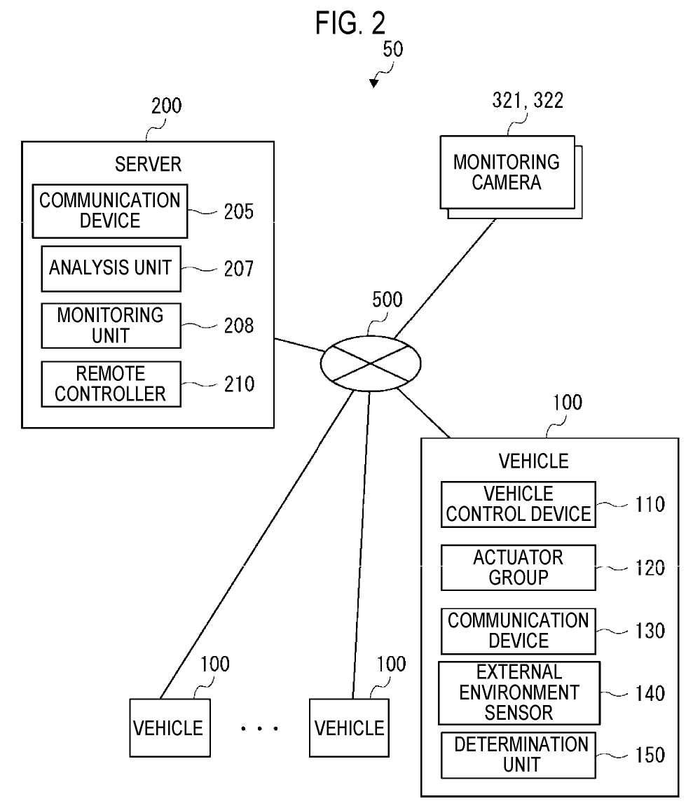

As shown in FIG. 2, the vehicle management system 50 includes a server 200 and a plurality of vehicles 100. Each of the vehicles 100 is, for example, an autonomous driving vehicle that can travel by itself during a manufacturing process. In other words, each of the vehicles 100 is, for example, a vehicle that can move by unmanned driving during the manufacturing process.

Each of the vehicles 100 is a vehicle before completion. Each of the vehicles 100 before completion is manufactured as a finished product by performing a predetermined operation from an operator (not shown) or a robot (not shown) in an area of each manufacturing process while moving in a formation along a movement route (track) set in advance. The predetermined operation is an operation such as assembly of a component, switch operation, welding, and inspection.

In addition, each of the vehicles 100 is equipped with an external environment sensor. The external environment sensor includes, for example, a vehicle-mounted camera that images the surroundings of the vehicle, a radar that detects an obstacle around the vehicle, and a light detection and ranging (LiDAR) that detects an obstacle around the vehicle. Each of the vehicles 100 detects a vehicle 100 in front (or behind) during traveling in formation or detects another obstacle around the vehicle body by using the external environment sensor. For example, each of the vehicles 100 images a vehicle 100 in front (or behind) during traveling in formation by using a vehicle-mounted camera that is one of the external environment sensors. Each of the vehicles 100 has a communication function and transmits the detection result (for example, data such as a captured image) of the external environment sensor to the server 200 via a network 500.

The monitoring camera 321 images the area A1 in which the vehicles 100 move in order. In the example of FIG. 1, the monitoring camera 321 is composed of three cameras. The monitoring camera 322 images the area A2 in which one vehicle 100 performs test traveling on a roller of a chassis dynamometer. In the example of FIG. 1, the monitoring camera 322 is composed of one camera.

The server 200 monitors and manages the vehicles 100 that are moving in the area A1 based on at least any of a captured image of the monitoring camera 321 that images the area A1 or the detection result such as a captured image received from the external environment sensor of each of the vehicles 100 that are moving in the area A1. In addition, the server 200 monitors and manages the vehicle 100 that is traveling in the area A2 based on at least any of a captured image of the monitoring camera 322 that images the area A2 or the detection result such as a captured image received from the external environment sensor of the vehicle 100 that is traveling in the area A2. For example, the server 200 monitors whether each of the vehicles 100 is moving along a scheduled route based on the acquired captured image or the like. For example, the server 200 monitors whether each of the vehicles 100 is being subjected to the predetermined operation as scheduled or whether the vehicle 100 that is traveling in a test is performing test traveling according to a designated traveling condition. In addition, the server 200 controls the movement of each of the vehicles 100 while estimating the position of each of the vehicles 100 based on the acquired captured image or the like. The server 200 is a vehicle management device and is also referred to as a vehicle management system.

Subsequently, a control system of the vehicle management system 50 will be described with reference to FIG. 2. FIG. 2 is a block diagram showing a control system of the vehicle management system 50.

As shown in FIG. 2, the server 200 includes at least a communication device 205, an analysis unit 207, a monitoring unit 208, and a remote controller 210. The server 200 is not limited to being configured by a single physical device and may be configured by a plurality of distributed devices. Each of the vehicles 100 includes a vehicle control device 110, an actuator group 120, a communication device 130, an external environment sensor 140, and a determination unit 150. As described above, the external environment sensor 140 includes a plurality of types of sensors such as a vehicle-mounted camera, a radar, and a LiDAR. Each of the vehicles 100 detects a vehicle 100 in front (or behind) during traveling in formation or detects another obstacle around the vehicle body by using the external environment sensor 140.

In the server 200, the communication device 205 communicates with the monitoring cameras 321, 322 and each of the vehicles 100 via the network 500. For example, the communication device 205 receives data such as a captured image from the monitoring cameras 321, 322, receives the detection result (information on an obstacle around the vehicle body) of the external environment sensor 140 from each of the vehicles 100, or transmits information on vehicle control to each of the vehicles 100.

The analysis unit 207 analyzes each of the captured image of the monitoring camera 321 that images the area A1 and the detection result of the external environment sensor 140 mounted on each of the vehicles 100 that is moving in the area A1. Specifically, the communication device 205 receives data such as a captured image from the monitoring camera 321 that images the area A1 and receives the detection result (data such as a captured image) from the external environment sensor 140 mounted on each of the vehicles 100 that is moving in the area A1. Then, the analysis unit 207 analyzes each of the captured image of the monitoring camera 321 that is received and the detection result of the external environment sensor 140 that is received. As a result, the analysis unit 207 specifies, for example, the external shape of each of the vehicles 100 that is moving in the area A1 and the peripheral environment of each of the vehicles 100 that is moving in the area A1. As a result, it is possible to specify the position and the orientation of each of the vehicles 100 in the area A1 and the traveling state of each of the vehicles 100 in the area A1.

In addition, the analysis unit 207 analyzes each of the captured image of the monitoring camera 322 that images the area A2 and the detection result of the external environment sensor 140 mounted on the vehicle 100 that is traveling on the roller in the area A2. Specifically, the communication device 205 receives data such as a captured image from the monitoring camera 322 that images the area A2 and receives the detection result (data such as a captured image) from the external environment sensor 140 mounted on the vehicle 100 that is traveling on the roller in the area A2. Then, the analysis unit 207 analyzes each of the captured image of the monitoring camera 322 that is received and the detection result of the external environment sensor 140 that is received. As a result, the analysis unit 207 specifies, for example, the external shape and the peripheral environment of the vehicle 100 that is traveling on the roller in the area A2. As a result, it is possible to specify the position and the orientation of the vehicle 100 on the roller in the area A2 and the traveling state of the vehicle 100 on the roller in the area A2.

The monitoring unit 208 monitors each of the vehicles 100 positioned in the areas A1, A2 based on the analysis result of the analysis unit 207. For example, the monitoring unit 208 monitors whether each of the vehicles 100 is moving while maintaining a vehicle-to-vehicle distance designated in advance. For example, the monitoring unit 208 monitors whether each of the vehicles 100 is moving along a scheduled route or whether each of the vehicles 100 is being subjected to the predetermined operation as scheduled. In addition, the monitoring unit 208 monitors whether the vehicle 100 that is traveling in a test is performing test traveling according to a designated traveling condition.

The remote controller 210 remotely controls each of the vehicles 100 by transmitting information on vehicle control to each of the vehicles 100 based on a monitoring result (including position information of each of the vehicles 100) of the monitoring unit 208. Specifically, the communication device 205 transmits information on vehicle control instructed by the remote controller 210 to each of the vehicles 100. In each of the vehicles 100, the communication device 130 receives information on vehicle control from the server 200, and the vehicle control device 110 causes the vehicle to travel by controlling the actuator group 120 in response to the received information on vehicle control.

In each of the vehicles 100, the determination unit 150 determines a communication status between the communication device 130 provided in the vehicle 100 and the communication device 205 provided in the server 200. In other words, in each of the vehicles 100, the determination unit 150 determines whether there is a communication interruption between the communication device 130 provided in the vehicle 100 and the communication device 205 provided in the server 200. Then, the vehicle control device 110 of the vehicle 100 that is determined to have a communication interruption with the server 200 controls the operation of the vehicle 100 to perform a predetermined operation according to the traveling area.

For example, in a case where the vehicle 100 is moving in the area A1, the vehicle control device 110 of the vehicle 100 that is determined to have a communication interruption with the server 200 stops the vehicle 100. In particular, in a case where access of the operator to the area A1 is permitted, the vehicle control device 110 of the vehicle 100 that is determined to have a communication interruption with the server 200 performs an emergency stop of the vehicle 100. As a result, safety is ensured.

Alternatively, in a case where the vehicle 100 is moving in the area A1, the vehicle control device 110 of the vehicle 100 that is determined to have a communication interruption with the server 200 may stop the vehicle 100 after the predetermined operation by the work robot or the like is completed, or may stop the vehicle 100 after deviating from the scheduled traveling route of another vehicle 100 traveling behind the vehicle 100.

Alternatively, in a case where the vehicle 100 is moving in the area A1, the vehicle control device 110 of the vehicle 100 that is determined to have a communication interruption with the server 200 may stop the vehicle 100 and may request the server 200, via the communication device 130, to stop the traveling of all the vehicles 100 that are moving in the area A1.

In addition, in a case where the vehicle 100 is traveling on the roller in the area A2, the vehicle control device 110 of the vehicle 100 that is determined to have a communication interruption with the server 200 gradually reduces the traveling speed of the vehicle 100. As a result, it is possible to prevent the vehicle body from flying out from the roller.

As described above, the vehicle 100 according to the present disclosure controls the vehicle to perform a predetermined operation according to the traveling area in a case where the communication with the server 200 is interrupted. For example, in a case where the vehicle 100 according to the present disclosure travels on a roller of a chassis dynamometer, the vehicle 100 gradually reduces the speed so that the vehicle body does not fly out from the roller, and in a case where the vehicle 100 travels in an area other than the roller, the vehicle 100 stops quickly. As a result, the vehicle 100 according to the present disclosure can execute an appropriate retreat operation in a case where the communication with the server 200 is interrupted.

The determination unit 150 of each of the vehicles 100 may determine the communication status (whether there is a communication interruption) between the communication device 130 provided in the vehicle 100 and the communication device 205 provided in the server 200 at a time interval according to the traveling area of the vehicle 100.

For example, in a case where the vehicle 100 is moving in an area A3 (not shown) having a short vehicle-to-vehicle distance, the determination unit 150 determines the communication status between the communication device 130 provided in the vehicle 100 and the communication device 205 provided in the server 200 at a relatively short time interval. That is, the determination unit 150 shortens the determination interval of the communication status between the communication device 130 provided in the vehicle 100 that is moving in the area A3 and the communication device 205 provided in the server 200, and does not allow a short-term communication interruption. As a result, it is possible to more reliably prevent the vehicle 100 from coming into contact with an adjacent vehicle.

In addition, in a case where the vehicle 100 is moving in an area A4 (not shown) having a long vehicle-to-vehicle distance, the determination unit 150 determines the communication status between the communication device 130 provided in the vehicle 100 and the communication device 205 provided in the server 200 at a relatively long time interval. That is, the determination unit 150 lengthens the determination interval of the communication status between the communication device 130 provided in the vehicle 100 that is moving in the area A4 and the communication device 205 provided in the server 200. As a result, by allowing a short-term communication interruption within a range where the vehicle 100 does not come into contact with an adjacent vehicle, it is possible to reduce the frequency of the emergency stop of the vehicle 100. As a result, the productivity of the vehicle is improved, and the cost is reduced.

The determination unit 150 is not limited to a case where the determination interval of the communication status is determined according to the vehicle-to-vehicle distance between the vehicle 100 and the adjacent vehicle, and the determination interval of the communication status may be determined according to a distance between the vehicle 100 and an obstacle other than the adjacent vehicle. The obstacle other than the adjacent vehicle is, for example, an operator, a work robot, or a tool storage. For example, in a case where the vehicle 100 travels in an area where the access of the operator is prohibited, the determination unit 150 may shorten the determination interval of the communication status as compared with a case where the vehicle 100 travels in an area where the access of the operator is permitted. Further, the determination unit 150 may shorten the determination interval of the communication status as the traveling speed of the vehicle 100 increases and may lengthen the determination interval of the communication status as the traveling speed of the vehicle 100 decreases.

Hereinafter, a traveling control example for controlling the traveling of the vehicle 100 in the system 50 related to the manufacturing of the vehicle including the vehicle management system according to the present disclosure will be described.

### A. Traveling Control Example 1

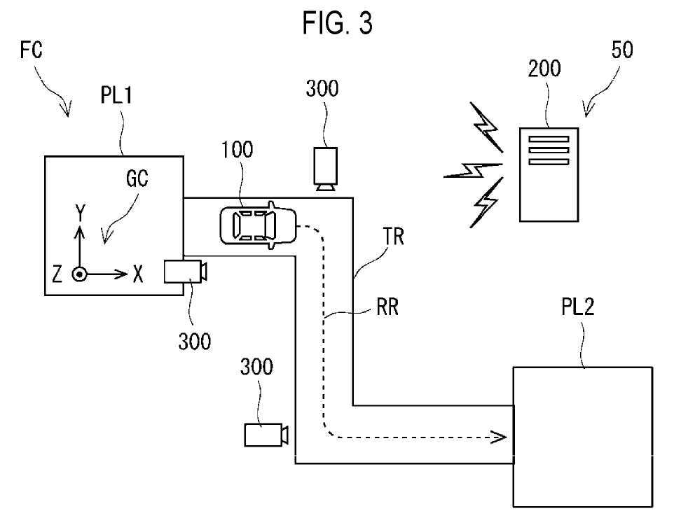

FIG. 3 is a conceptual diagram showing a configuration of the system 50 in the traveling control example 1. The system 50 includes one or more vehicles 100 as a moving object, the server 200, and one or more external sensors 300.

In addition, in a case where the moving object is other than a vehicle, the expression of "vehicle" and "car" in the present disclosure can be replaced with "moving object" as appropriate, and the expression of "travel" can be replaced with "move" as appropriate.

The vehicle 100 is configured to travel via unmanned driving. The "unmanned driving" means driving that does not depend on a traveling operation of an occupant. The traveling operation means an operation related to at least any one of "traveling", "turning", and "stopping" of the vehicle 100. The unmanned driving is implemented by automatic or manual remote control using a device located outside the vehicle 100 or by autonomous control of the vehicle 100. The occupant who does not perform the traveling operation may get on the vehicle 100 that travels via the unmanned driving. Examples of the occupant who does not perform the traveling operation include a person who simply sits on a seat of the vehicle 100 and a person who performs work different from the traveling operation, such as assembly, inspection, or operation of switches, in a state of getting on the vehicle 100. The driving via the traveling operation performed by the occupant may be referred to as "manned driving".

In the present specification, the "remote control" includes "complete remote control" in which all the operations of the vehicle 100 are completely decided from the outside of the vehicle 100, and "partial remote control" in which a part of the operations of the vehicle 100 is decided from the outside of the vehicle 100. In addition, the "autonomous control" includes "complete autonomous control" in which the vehicle 100 autonomously controls its own operation without receiving any information from a device outside the vehicle 100. The "autonomous control" includes "partial autonomous control" in which the vehicle 100 autonomously controls its own operation using information received from a device outside the vehicle 100.

In the present embodiment, the system 50 is used in a factory FC that manufactures the vehicle 100. A reference coordinate system of the factory FC is a global coordinate system GC. That is, any position in the factory FC is represented by coordinates of X, Y, and Z in the global coordinate system GC. The factory FC includes a first place PL1 and a second place PL2. The first place PL1 and the second place PL2 are connected by a track TR on which the vehicle 100 can travel. A plurality of external sensors 300 is installed in the factory FC along the track TR. A position of each of the external sensors 300 in the factory FC is adjusted in advance. The vehicle 100 moves via the unmanned driving from the first place PL1 to the second place PL2 along the track TR.

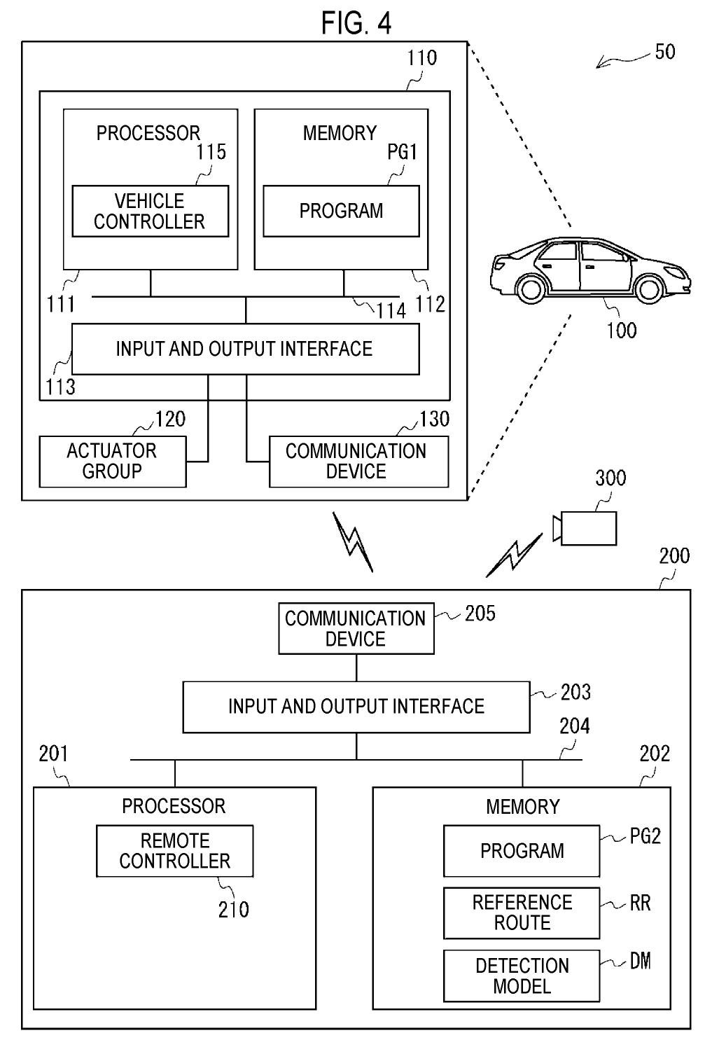

FIG. 4 is a block diagram showing the configuration of the system 50. The vehicle 100 includes a vehicle control device 110 for controlling each part of the vehicle 100 and an actuator group 120 including one or more actuators that are driven under the control of the vehicle control device 110. The vehicle 100 includes a communication device 130 for communicating with an external device such as the server 200 by wireless communication. The actuator group 120 includes an actuator of a drive device for accelerating the vehicle 100, an actuator of a steering device for changing a traveling direction of the vehicle 100, and an actuator of a braking device for decelerating the vehicle 100.

The vehicle control device 110 is configured by a computer including a processor 111, a memory 112, an input and output interface 113, and an internal bus 114. The processor 111, the memory 112, and the input and output interface 113 are connected to be bidirectionally communicable with each other via the internal bus 114. The actuator group 120 and the communication device 130 are connected to the input and output interface 113. The processor 111 executes a program PG1 stored in the memory 112 to implement various functions including functions as a vehicle controller 115.

The vehicle controller 115 controls the actuator group 120 to cause the vehicle 100 to travel. The vehicle controller 115 can cause the vehicle 100 to travel by controlling the actuator group 120 using a traveling control signal received from the server 200. The traveling control signal is a control signal for causing the vehicle 100 to travel. In the present embodiment, the traveling control signal includes the acceleration and a steering angle of the vehicle 100 as parameters. In other embodiments, the traveling control signal may include a speed of the vehicle 100 as the parameter instead of or in addition to the acceleration of the vehicle 100.

The server 200 is configured by a computer including a processor 201, a memory 202, an input and output interface 203, and an internal bus 204. The processor 201, the memory 202, and the input and output interface 203 are connected to be bidirectionally communicable with each other via the internal bus 204. A communication device 205 for communicating with various devices outside the server 200 is connected to the input and output interface 203. The communication device 205 can communicate with the vehicle 100 via wireless communication, and can communicate with each of external sensors 300 via wired communication or wireless communication. The processor 201 implements various functions including a function as a remote controller 210 by executing a program PG2 stored in the memory 202.

The remote controller 210 acquires a detection result of the sensor. The remote controller 210 generates the traveling control signal for controlling the actuator group 120 of the vehicle 100 using the detection result, and causes the vehicle 100 to travel by transmitting the traveling control signal to the vehicle 100 via the remote control. The remote controller 210 may generate, for example, a control signal for controlling various accessories provided in the vehicle 100 or actuators for operating various kinds of equipment, such as a wiper, a power window, or a lamp, in addition to the traveling control signal, and output the generated control signal. That is, the remote controller 210 may operate the various kinds of equipment or the various accessories via the remote control. For example, the remote controller 210 may include functions of the analysis unit 207 and the monitoring unit 208 shown separately from the remote controller 210 in FIG. 2.

The external sensor 300 is a sensor located outside the vehicle 100. The external sensor 300 according to the present embodiment is a sensor that captures the vehicle 100 from the outside of the vehicle 100. The external sensor 300 includes a communication device (not shown), and can communicate with other devices, such as the server 200, via wired communication or wireless communication.

Specifically, the external sensor 300 is configured by a camera. The camera as the external sensor 300 captures a captured image including the vehicle 100 and outputs the captured image as a detection result.

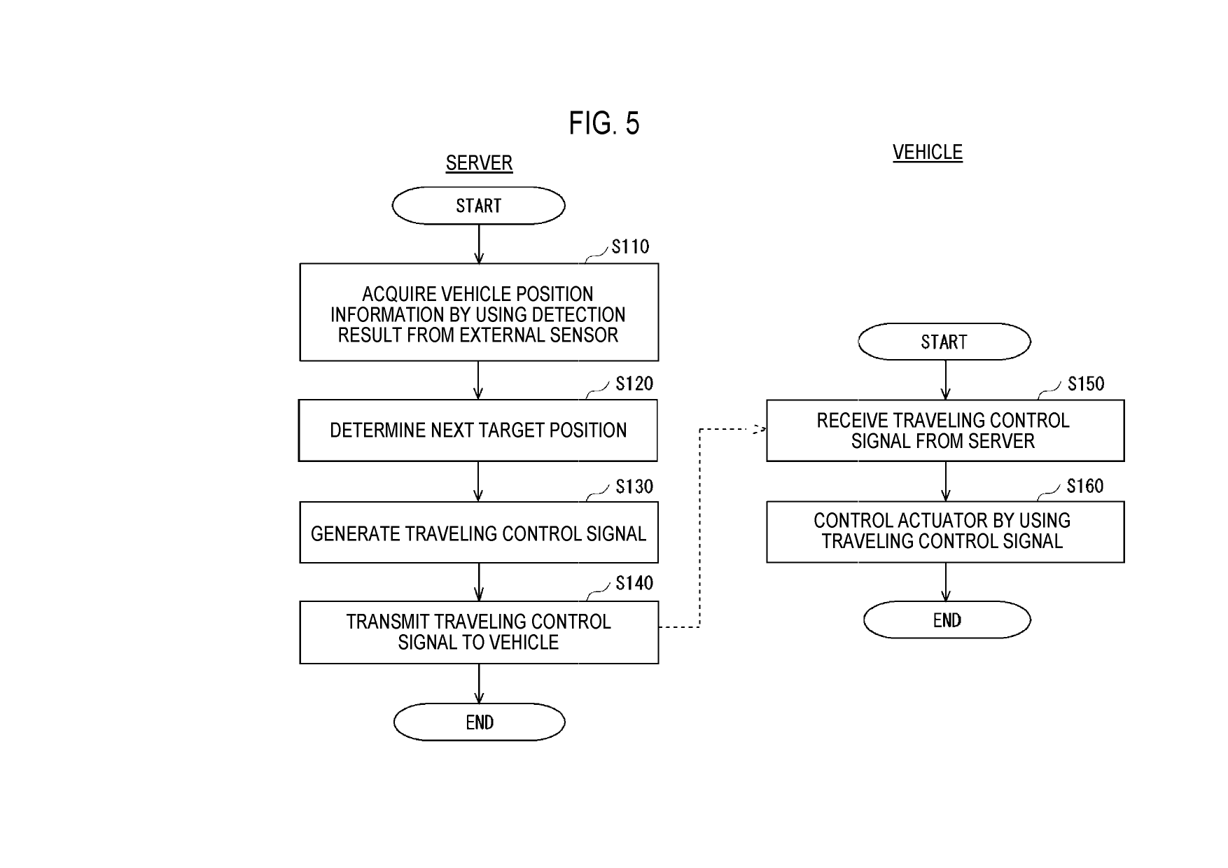

FIG. 5 is a flowchart showing a processing procedure of the traveling control of the vehicle 100 in the traveling control example. In the processing procedure of FIG. 5, the processor 201 of the server 200 executes the program PG2 to function as the remote controller 210. In addition, the processor 111 of the vehicle 100 executes the program PG1 to function as the vehicle controller 115.

In S110, the processor 201 of the server 200 acquires the vehicle position information of the vehicle 100 by using the detection result output from the external sensor 300. The vehicle position information is position information that is a basis for generating the traveling control signal. In the present embodiment, the vehicle position information includes the position and the direction of the vehicle 100 in the global coordinate system GC of the factory FC. Specifically, in step S110, the processor 201 acquires the vehicle position information by using the captured image acquired from the camera as the external sensor 300.

Specifically, in S110, the processor 201 detects, for example, the external shape of the vehicle 100 from the captured image and calculates the coordinates of the positioning point of the vehicle 100 in the coordinate system of the captured image, that is, the local coordinate system. In S110, the processor 201 acquires the position of the vehicle 100, for example, by converting the calculated coordinates into coordinates in the global coordinate system GC. The outer shape of the vehicle 100 included in the captured image can be detected, for example, by inputting the captured image to a detection model DM using artificial intelligence. The detection model DM is prepared, for example, inside the system 50 or outside the system 50, and is stored in advance in the memory 202 of the server 200. Examples of the detection model DM include a trained machine learning model that has been trained to implement any one of semantic segmentation and instance segmentation. As the machine learning model, for example, a convolutional neural network (CNN) that has been trained by supervised learning using a training data set can be used. The training data set has, for example, a plurality of training images including the vehicle 100 and a label indicating whether each area in the training image is an area indicating the vehicle 100 or an area indicating an area other than the vehicle 100. When the CNN is trained, it is preferable that parameters of the CNN are updated such that an error between an output result of the detection model DM and the label is reduced by backpropagation (error backpropagation method). The processor 201 can acquire the direction of the vehicle 100 by performing the estimation based on a direction of a movement vector of the vehicle 100 calculated from a positional change in a feature point of the vehicle 100 between frames of the captured image by using, for example, an optical flow method.

In S120, the processor 201 of the server 200 determines a target position to which the vehicle 100 should head next. In the present embodiment, the target position is represented by the coordinates of X, Y, and Z in the global coordinate system GC. The reference route RR that is a route along which the vehicle 100 should travel is stored in advance in the memory 202 of the server 200. The route is represented by a node indicating a departure point, a node indicating a passing point, a node indicating a destination, and a link connecting the respective nodes. The processor 201 decides the target position to which the vehicle 100 should head next by using the vehicle position information and the reference route RR. The processor 201 decides the target position on the reference route RR ahead of the current position of the vehicle 100.

In step S130, the processor 201 of the server 200 generates the traveling control signal for causing the vehicle 100 to travel toward the decided target position. The processor 201 calculates the traveling speed of the vehicle 100 from the transition of the position of the vehicle 100, and compares the calculated traveling speed with a target speed. As a whole, the processor 201 decides the acceleration such that the vehicle 100 is accelerated when the traveling speed is lower than the target speed, and decides the acceleration such that the vehicle 100 is decelerated when the traveling speed is higher than the target speed. In addition, the processor 201 determines the steering angle and the acceleration such that the vehicle 100 does not deviate from the reference route RR in a case where the vehicle 100 is positioned on the reference route RR. In a case where the vehicle 100 is not located on the reference route RR, in other words, in a case where the vehicle 100 deviates from the reference route RR, the processor 201 decides the steering angle and the acceleration such that the vehicle 100 returns to the reference route RR.

In S140, the processor 201 of the server 200 transmits the generated traveling control signal to the vehicle 100. The processor 201 repeatedly executes, at a predetermined cycle, the acquisition of the position of the vehicle 100, the decision of the target position, the generation of the traveling control signal, and the transmission of the traveling control signal.

In S150, the processor 111 of the vehicle 100 receives the traveling control signal transmitted from the server 200. In step S160, the processor 111 of the vehicle 100 controls the actuator group 120 by using the received traveling control signal, to cause the vehicle 100 to travel at the acceleration and the steering angle represented by the traveling control signal. The processor 111 repeatedly executes, at a predetermined cycle, the reception of the traveling control signal and control of the actuator group 120. With the system 50 according to the present embodiment, the vehicle 100 can be caused to travel by the remote control, and the vehicle 100 can move without using a transport facility, such as a crane or a conveyor.

### B: Traveling Control Example 2

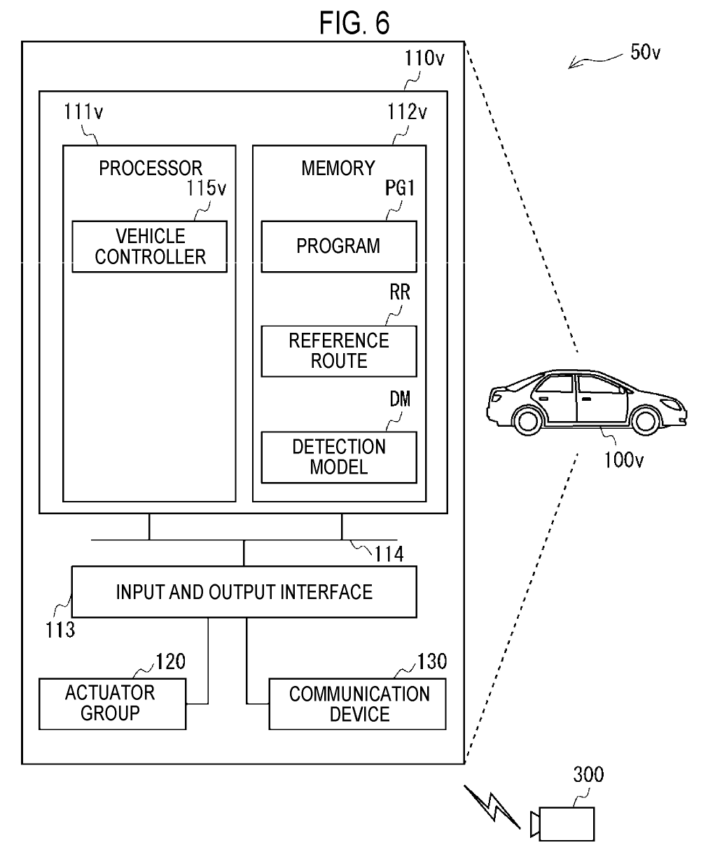

FIG. 6 is an explanatory diagram showing a schematic configuration of a system 50v in the traveling control example 2. In the present example, the system 50v is different from the traveling control example 1 in that the system 50v does not include the server 200. In addition, the vehicle 100v in the configuration can travel by autonomous control of the vehicle 100v. The other configurations are the same as those described above unless otherwise specified.

In the present example, the processor 111v of the vehicle control device 110v functions as the vehicle controller 115v by executing the program PG1 stored in the memory 112v. The vehicle controller 115v can acquire the output result of the sensor, generate the traveling control signal by using the output result, and output the generated traveling control signal to operate the actuator group 120, thereby causing the vehicle 100v to travel via the autonomous control. In the present example, the detection model DM and the reference route RR are stored in the memory 112v in addition to the program PG1.

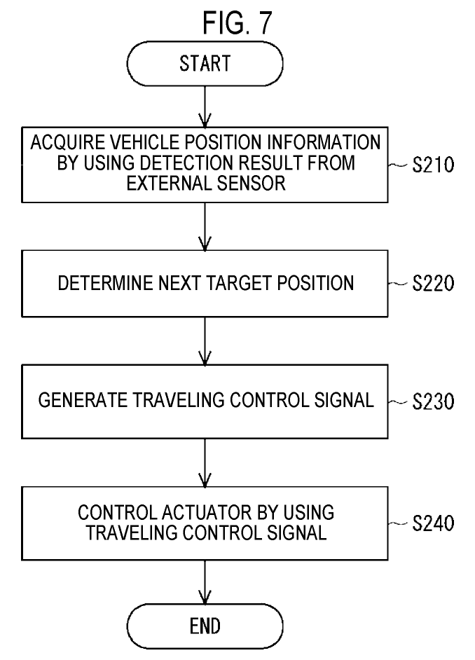

FIG. 7 is a flowchart showing a processing procedure of the traveling control of the vehicle 100v in Example 2. In the processing procedure of FIG. 7, the processor 111v of the vehicle 100v executes the program PG1 to function as the vehicle controller 115v.

In S210, the processor 111v of the vehicle control device 110v acquires the vehicle position information by using the detection result output from the camera that is the external sensor 300. In S220, the processor 111v determines a target position to which the vehicle 100v should head next. In step S230, the processor 111v generates the traveling control signal for causing the vehicle 100v to travel toward the decided target position. In step S240, the processor 111v controls the actuator group 120 by using the generated traveling control signal, to cause the vehicle 100v to travel in accordance with the parameters represented by the traveling control signal. The processor 111v repeatedly executes, at a predetermined cycle, the acquisition of the vehicle position information, the decision of the target position, the generation of the traveling control signal, and the control of the actuator. With the system 50v according to the present embodiment, the vehicle 100v can be caused to travel via the autonomous control of the vehicle 100v without the need for the server 200 to remotely control the vehicle 100v.

### YY: Other Traveling Control Examples

(YY1) In the above example, the external sensor 300 is a camera. However, the external sensor 300 need not be the camera, and may be, for example, a light detection and ranging (LiDAR). In this case, the detection result output by the external sensor 300 may be three-dimensional point cloud data representing the vehicle 100. In this case, the server 200 or the vehicle 100 may acquire the vehicle position information via template matching using the three-dimensional point cloud data as the detection result, and reference point cloud data prepared in advance.

(YY2) In the traveling control example 1, the processing from the acquisition of the vehicle position information to the generation of the traveling control signal is executed by the server 200. On the other hand, the vehicle 100 may execute at least a part of the processing from the acquisition of the vehicle position information to the generation of the traveling control signal. For example, the following forms (1) to (3) may be used.
(1) The server 200 may acquire the vehicle position information, decide the target position to which the vehicle 100 should head next, and generate the route from the current position of the vehicle 100 represented by the acquired vehicle position information to the target position. The server 200 may generate a route to the target position between the current position and the destination or may generate a route to the destination. The server 200 may transmit the generated route to the vehicle 100. The vehicle 100 may generate the traveling control signal for causing the vehicle 100 to travel on the route received from the server 200, and control the actuator group 120 by using the generated traveling control signal.
(2) The server 200 may acquire the vehicle position information and transmit the acquired vehicle position information to the vehicle 100. The vehicle 100 may decide the target position to which the vehicle 100 should head next and generate the route from the current position of the vehicle 100 represented by the received vehicle position information to the target position. The vehicle 100 may generate the traveling control signal for causing the vehicle 100 to travel on the generated route, and control the actuator group 120 by using the generated traveling control signal.
(3) In each of the above-described forms (1) and (2), an internal sensor may be mounted on the vehicle 100, and a detection result output from the internal sensor may be used for at least one of the generation of the route and the generation of the traveling control signal. The internal sensor is a sensor mounted on the vehicle 100 and corresponds to the external environment sensor 140 shown in FIG. 2. The internal sensor may include, for example, a sensor that detects a motion state of the vehicle 100, a sensor that detects an operation state of each unit of the vehicle 100, or a sensor that detects a surrounding environment of the vehicle 100. Specifically, the internal sensor may include, for example, a camera, a LiDAR, a millimeter wave radar, an ultrasound sensor, a GPS sensor, an acceleration sensor, and a gyro sensor. For example, in the above-described form (1), the server 200 may acquire the detection result of the internal sensor and reflect the detection result of the internal sensor in the route when the route is generated. In the above-described form (1), the vehicle 100 may acquire the detection result of the internal sensor and reflect the detection result of the internal sensor to the traveling control signal when the traveling control signal is generated. In the above-described form (2), the vehicle 100 may acquire the detection result of the internal sensor and reflect the detection result of the internal sensor to the route when the route is generated. In the above-described form (2), the vehicle 100 may acquire the detection result of the internal sensor and reflect the detection result of the internal sensor to the traveling control signal when the traveling control signal is generated.

(YY3) In the traveling control example 2, an internal sensor may be mounted on the vehicle 100v, and the detection result output from the internal sensor may be used for at least one of the generation of the route or the generation of the traveling control signal. For example, the vehicle 100v may acquire the detection result of the internal sensor and reflect the detection result of the internal sensor to the route when the route is generated. The vehicle 100v may acquire the detection result of the internal sensor and reflect the detection result of the internal sensor to the traveling control signal when the traveling control signal is generated.

(YY4) In the traveling control example 2, the vehicle 100v acquires the vehicle position information by using the detection result of the external sensor 300. On the other hand, the vehicle 100v is equipped with an internal sensor, and the vehicle 100v acquires the vehicle position information by using the detection result of the internal sensor. The vehicle 100v may determine the target position to which the vehicle 100v should head next. The vehicle 100v may generate a route from the current location of the vehicle 100v represented by the acquired vehicle position information to the target position, generate a traveling control signal for traveling on the generated route, and control the actuator group 120 using the generated traveling control signal. In this case, the vehicle 100v can travel without using the detection result of the external sensor 300 at all. The vehicle 100v may acquire a target arrival time or traffic jam information from the outside of the vehicle 100v and reflect the target arrival time or the traffic jam information to at least one of the route and the traveling control signal. In addition, all of the functions of the system 50v may be provided in the vehicle 100v. That is, the processing implemented by the system 50v according to the present disclosure may be implemented by the vehicle 100v alone.

(YY5) In the traveling control example 1, the server 200 automatically generates the traveling control signal to be transmitted to the vehicle 100. On the other hand, the server 200 may generate the traveling control signal to be transmitted to the vehicle 100 in response to an operation of an external operator who is located outside the vehicle 100. For example, the external operator may operate a control device including a display that displays the captured image output from the external sensor 300, a steering wheel, an accelerator pedal, and a brake pedal for remotely operating the vehicle 100, and a communication device that communicates with the server 200 via the wired communication or the wireless communication. The server 200 may generate the traveling control signal in accordance with the operation applied to the control device.

(YY6) In each of the traveling control examples, the vehicle 100 may have a configuration that can move by unmanned driving, and may have, for example, a form of a platform including a configuration described below. Specifically, the vehicle 100 need solely include at least the vehicle control device 110 and the actuator group 120, in order to exhibit the three functions of "traveling", "turning", and "stopping" via the unmanned driving. In a case where the vehicle 100 acquires the information from the outside for the unmanned driving, the vehicle 100 need solely further include the communication device 130. That is, the vehicle 100 that can move via the unmanned driving need not be equipped with at least a part of interior components, such as a driver's seat and a dashboard. The vehicle 100 that can move by unmanned driving may not be equipped with at least a part of exterior components such as a bumper and a fender, and may not be equipped with a body shell. In this case, the vehicle 100 may be equipped with the remaining components, such as the body shell, before the vehicle 100 is shipped from the factory FC. The vehicle 100 may be equipped with the remaining components, such as the body shell, after the vehicle 100 is shipped from the factory FC in a state where the vehicle 100 is not equipped with the remaining components, such as the body shell. Each component may be mounted from any direction, such as the upper side, the lower side, the front side, the rear side, the right side, or the left side of the vehicle 100, and may be mounted from the same direction or different directions. The position decision can be made for the form of the platform in the same manner as the vehicle 100 according to the first embodiment.

(YY7) The vehicle 100 may be manufactured by combining a plurality of modules. The module means a unit configured by a plurality of components assembled depending on the part or the function of the vehicle 100. For example, the platform of the vehicle 100 may be manufactured by combining a front module that constitutes a front portion of the platform, a center module that constitutes a center portion of the platform, and a rear module that constitutes a rear portion of the platform. In addition, the number of modules constituting the platform is not limited to three, and may be two or less or four or more. In addition to or instead of the components constituting the platform, the components constituting a portion of the vehicle 100 that is different from the platform may be modularized. In addition, various modules may include any exterior component, such as a bumper or a grille, or any interior component, such as a seat or a console. The present disclosure is not limited to the vehicle 100, a moving object of any aspect may be manufactured by combining the modules. Such a module may be manufactured, for example, by joining the components via welding, a fastener, or the like, or may be manufactured by integrally molding at least a part of the components constituting the modules as one component via casting. A molding method of integrally molding one component, particularly a relatively large component, is also called giga casting or mega casting. For example, the front module, the center module, and the rear module may be manufactured by using giga casting.

(YY8) The transport of the vehicle 100 using the traveling of the vehicle 100 via the unmanned driving is also referred to as "autonomous driving transport". A configuration for implementing the autonomous driving transport is also referred to as "vehicle remote control autonomous driving transport system". A production method of producing the vehicle 100 by using the autonomous driving transport is also referred to as "autonomous driving production". In the autonomous driving production, for example, at the factory FC that manufactures the vehicle 100, at least a part of the transport of the vehicle 100 is implemented by the autonomous driving transport.

(YY9) In each of the traveling control examples, a part or all of functions and processing implemented by software may be implemented by hardware. Alternatively, a part or all of the functions and the processing that are implemented by hardware may be implemented by software. As the hardware for implementing various functions in each of the above-described embodiments, for example, various circuits, such as an integrated circuit or a discrete circuit, may be used.

The present disclosure can implement a part or all of the processing in the external sensor 300, the vehicle 100, the server 200, and the like described above by causing a central processing unit (CPU) to execute a computer program.

In addition, the program includes an instruction group (or software code) for causing a computer to execute one or more functions described in the embodiment in a case where the program is read into the computer. The program may be stored on a non-transitory computer-readable medium or a tangible storage medium. As an example, but not limited thereto, the computer-readable medium or the tangible storage medium includes a random-access memory (RAM), a read-only memory (ROM), a flash memory, a solid-state drive (SSD), or other memory technologies, a CD-ROM, a digital versatile disc (DVD), a Blu-ray (registered trademark) disc, or other optical disc storage, a magnetic cassette, a magnetic tape, a magnetic disk storage, or other magnetic storage devices. The program may be transmitted on a transitory computer-readable medium or a communication medium. Examples of the transitory computer-readable medium or the communication medium include electrical, optical, acoustic, or other forms of propagating signals, but the transitory computer-readable medium or the communication medium is not limited to these examples.

Although the present disclosure has been described with reference to the embodiments, the present disclosure is not limited to the above-described embodiments. Various changes can be made to the configurations and details of the present disclosure within the scope of the present disclosure that can be understood by those skilled in the art. Each embodiment can be appropriately combined with other embodiments.

What is claimed is:

1. A vehicle that operates in response to an instruction from a management device and that is able to move via unmanned driving, the vehicle comprising:
a communication unit configured to communicate with the management device;
a determination unit configured to determine a communication status between the communication unit and the management device; and
a controller configured to control, in a case where determination is made that communication between the communication unit and the management device is interrupted, the vehicle such that the vehicle performs a predetermined operation according to a traveling area.

2. The vehicle according to claim 1, wherein the controller is configured to perform, in a case where determination is made that the communication between the communication unit and the management device is interrupted while the vehicle is traveling in a traveling area accessible to an operator, an emergency stop of the traveling of the vehicle.

3. The vehicle according to claim 1, wherein the controller is configured to stop, in a case where determination is made that the communication between the communication unit and the management device is interrupted while the vehicle is traveling together with another vehicle positioned behind the vehicle, the traveling of the vehicle after the vehicle deviates from a scheduled traveling route of the other vehicle that travels behind the vehicle.

4. The vehicle according to claim 1, wherein the controller is configured to gradually reduce, in a case where determination is made that the communication between the communication unit and the management device is interrupted while the vehicle is traveling on rollers of a chassis dynamometer, a traveling speed of the vehicle.

5. The vehicle according to claim 1, wherein the determination unit is configured to determine the communication status between the communication unit and the management device at intervals according to the traveling area of the vehicle.
